(19) United States
(12) Patent Application Publication
(10) Pub. No.: US 2020/0276695 A1
(43) Pub. Date: Sep. 3, 2020

(54) ERGONOMIC POLE FOR AN IMPLEMENT

(71) Applicant: Unger Marketing International, LLC, Bridgeport, CT (US)

(72) Inventor: James M. Buckley, New Hartford, CT (US)

(21) Appl. No.: 16/796,414

(22) Filed: Feb. 20, 2020

Related U.S. Application Data
(60) Provisional application No. 62/811,822, filed on Feb. 28, 2019.

(51) Int. Cl. B25G 1/10; B25G 1/04

(52) U.S. Cl. CPC B25G 1/10; A47L 13/00; B25G 1/04

(57) ABSTRACT

An ergonomic pole for a floor cleaning implement is provided. In an embodiment, the ergonomic pole comprising a pole having a first end and a second end, the pole further having a first segment adjacent the first end, a third segment adjacent the second end and a second segment disposed between the first segment and third segment. A cleaning implement is coupled to the first end. Wherein the third segment is disposed on an angle of about 25 degrees to 40 degrees relative to the surface when in an operating position. Wherein the second end is positioned about 630-1400 mm from the surface when in the operating position.

### CROSS REFERENCE TO RELATED APPLICATIONS

This application claims the benefit of U.S. Provisional Application Ser. No. 62/811,822, filed Feb. 28, 2019, the entire disclosure of which is incorporated herein by reference.

### BACKGROUND

The subject matter disclosed herein relates to a handle or pole for use with a cleaning implement such as a floor squeegee, broom, brush or mop for example, and in particular to an ergonomic shaped pole that facilitates the user's use of the pole.

Handles for cleaning implements that require continuous forward and downward forces, such as brooms or squeegees for example, typically have straight poles. Due to a need to apply a downward and forward force simultaneously, the user typically puts a palm of one hand on the end of the pole and their other hand part partially down the pole. In order to keep the cleaning implement at a desired angle for efficient operation (e.g. squeegees will chatter if not held at a desired angle), and because the poles are straight, the user will assume a bent over position while using the cleaning implement. This is obviously less than desired because it could lead to faster fatigue.

Accordingly while existing poles are suitable for their intended purposes the need for improvement remains, particularly in providing an ergonomic shape pole having the features described herein.

### BRIEF DESCRIPTION

According to one aspect of the disclosure an ergonomic pole for a floor cleaning implement is provided. The ergonomic pole comprising a pole having a first end and a second end, the pole further having a first segment adjacent the first end, a third segment adjacent the second end and a second segment disposed between the first segment and third segment. A cleaning implement is coupled to the first end. Wherein the third segment is disposed on an angle of about 25 degrees to 40 degrees relative to the surface when in an operating position. Wherein the second end is positioned about 630-1400 mm from the surface when in the operating position.

Additionally or alternatively, in this or other embodiments, the first segment is disposed on an angle of about 30 to 60 degrees when in the operating position. Additionally or alternatively, in this or other embodiments, the first segment is disposed on an angle of about 35-50 degrees when in the operating position. Additionally or alternatively, in this or other embodiments, a horizontal distance relative to a surface being cleaned from the first end to the second end is about 750-1100 mm. Additionally or alternatively, in this or other embodiments, the second segment is configured to change length.

Additionally or alternatively, in this or other embodiments, the pole includes a first curved portion between the first segment and the second segment, and a second curved portion between the second segment and the third segment. Additionally or alternatively, in this or other embodiments, the first segment has a first axis, the second segment has a second axis, and the third segment includes a third axis, a first intersection of the first axis and the second axis defining a first datum point, a second intersection of the second axis and the third axis defining a second datum point. Additionally or alternatively, in this or other embodiments, the third segment has a length of about 670-790 mm from the second datum point to the second end.

Additionally or alternatively, in this or other embodiments, the first segment has a length of about 150-270 mm inches from the first end to the first datum. Additionally or alternatively, in this or other embodiments, the second segment is adjustable from a first length to a second length, the height H changes from 635 mm to 1270 mm when the second segment changes from the first length to the second length and the implement is at a functional angle. Additionally or alternatively, in this or other embodiments, the functional angle is between 30 to 60 degrees. Additionally or alternatively, in this or other embodiments, the functional angle is between 35 to 50 degrees.

According to another aspect of the disclosure an ergonomic pole for a floor cleaning implement is provided. The ergonomic pole comprises a pole having a first end and a second end, the pole further having a first segment adjacent the first end, a third segment adjacent the second end and a second segment disposed between the first segment and third segment, the first segment having a first axis, the second segment having a second axis and the third segment having a third axis, a first intersection of the first axis and the second axis defining a first datum point, a second intersection of the second axis and the third axis defining a second datum point. A cleaning implement is coupled to the first end. Wherein the pole has the dimensions A₃, A₁, and H as defined by Table 2.

Additionally or alternatively, in this or other embodiments, the pole has the dimensions A₁, A₃ and H as defined by Table 1. Additionally or alternatively, in this or other embodiments, the pole has the dimensions D₁ and D₃ as defined by Table 3. Additionally or alternatively, in this or other embodiments, the pole has the dimension D2 as defined by Table 3. Additionally or alternatively, in this or other embodiments, the pole further comprises a first curved segment connected between the first segment and the second segment, and a second curved segment connected between the second segment and the third segment. Further, the first curved segment has a radius defined by dimension R₁ as defined by Table 3 and the second curved segment has a radius defined by dimension R₂ as defined by Table 3.

Additionally or alternatively, in this or other embodiments, the pole has the dimensions A₂, as defined by Table 1. Additionally or alternatively, in this or other embodiments, the second segment is configured to have an adjustable length. Additionally or alternatively, in this or other embodiments, the ergonomic pole further comprises a coupler member coupled to an end of the first segment. Additionally or alternatively, in this or other embodiments, the coupler member has a threaded portion configured to couple the coupler member to the cleaning implement.

Additionally or alternatively, in this or other embodiments, the coupler includes a threaded portion, and the cleaning implement is coupled to the coupler with the threaded portion. Additionally or alternatively, in this or other embodiments, the ergonomic pole further comprises a handle coupled to an end of the third segment. Additionally or alternatively, in this or other embodiments, the ergonomic pole further comprises a grip member coupled to the third segment.

According to yet another aspect of the disclosure an ergonomic pole for a floor cleaning implement is provided. The ergonomic pole comprises a pole having a first end and a second end, the pole further having a first segment adjacent the first end, a third segment adjacent the second end and a second segment disposed between the first segment and third segment. A cleaning implement is coupled to the first end. Wherein the first segment is disposed on a functional angle of about 30 degrees to 60 degrees relative to the surface when in an operating position. Wherein the second segment is adjustable from a first length to a second length, the height of an end of the third segment above the surface when in an operating position changes from 635 mm to 1270 mm when the second segment changes from the first length to the second length.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of a pole for an implement in accordance with an embodiment;

FIG. 2 is a side view of the pole of FIG. 1, the opposite side being a mirror image thereof;

FIG. 3 is a front view of the pole of FIG. 1;

FIG. 4 is a rear view of the pole of FIG. 1;

FIG. 5 is a top view of the pole of FIG. 1;

FIG. 6 is a bottom view of the pole of FIG. 1;

FIG. 7A, 7B and FIG. 7C are various unassembled perspective views of the pole of FIG. 1;

FIG. 8 is a schematic side view of the pole of FIG. 1;

FIG. 9 is a perspective view of a pole for an implement in accordance with another embodiment;

FIG. 10 is a side view of the pole of FIG. 9, the opposite side being a mirror image thereof;

FIG. 11 is a front view of the pole of FIG. 9;

FIG. 12 is a rear view of the pole of FIG. 9;

FIG. 13 is a top view of the pole of FIG. 9;

FIG. 14 is a bottom view of the pole of FIG. 9;

FIG. 15 is a schematic side view of the pole of FIG. 9;

FIG. 16 is a perspective view of a pole for an implement in accordance with another embodiment;

FIG. 17 is a side view of the pole of FIG. 16, the opposite side being a mirror image thereof;

FIG. 18 is a front view of the pole of FIG. 16;

FIG. 19 is a rear view of the pole of FIG. 16;

FIG. 20 is a top view of the pole of FIG. 16;

FIG. 21 is a bottom view of the pole of FIG. 16;

FIG. 22 is a schematic side view of the pole of FIG. 9;

FIG. 23 is a schematic side view of a pole for an implement in accordance with another embodiment;

FIG. 24 is a schematic side view of a pole for an implement in accordance with another embodiment;

FIG. 25A and FIG. 25B are a perspective view and a side view of a pole having a curved upper segment in accordance with another embodiment;

FIG. 26A and FIG. 26B are a perspective view and a side view of a pole having a curved upper segment in accordance with another embodiment; and

FIG. 27A and FIG. 27B are a perspective view and a side view of a pole having a curved upper segment in accordance with another embodiment.

The detailed description explains embodiments of the disclosure, together with advantages and features, by way of example with reference to the drawings.

### DETAILED DESCRIPTION

Embodiments of the present disclosure provide for an ergonomic pole that is used with implements, such as cleaning implements, squeegees, brooms, brushes, mops, plows, or poles, which allows the user to provide forces in the desired direction(s)/vectors without substantially bending their back during normal operation. Embodiments of the present disclosure further provide for an ergonomic pole for use with implements that has an adjustable length to accommodate a user's height.

Ergonomic poles have been proposed for use with tools, such as snow shovels for example. These poles allow a user to lift material (e.g. snow or dirt) without having the user bending as far down, allowing them to more efficiently use their legs in a lifting motion to reduce stain on their back. Further, the shape of the pole allows the user to place on of their hands close to the shovel end for stability. These lifting ergonomic poles are unsuitable for use with other types of cleaning implements, such as brooms or squeegees. For these types of cleaning implements, the user is not lifting material, but rather is placing a downward force and a forward force simultaneously while in use. Unlike a shovel which has intermittent usage, the forces on a broom or squeegee are more continuous. Further, some cleaning implements such as squeegees are held within a predetermined angle during use for efficient operation. When a squeegee is held outside of this angular range, the squeegee blade may chatter or bounce, causing portions of the liquids being removed to be left behind or have an increased force required to push the squeegee forward to clean/move the material/debris.

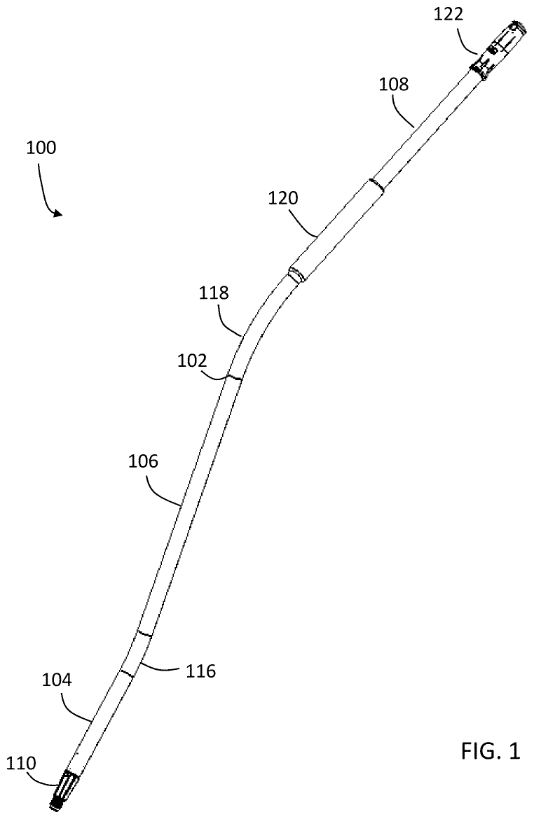

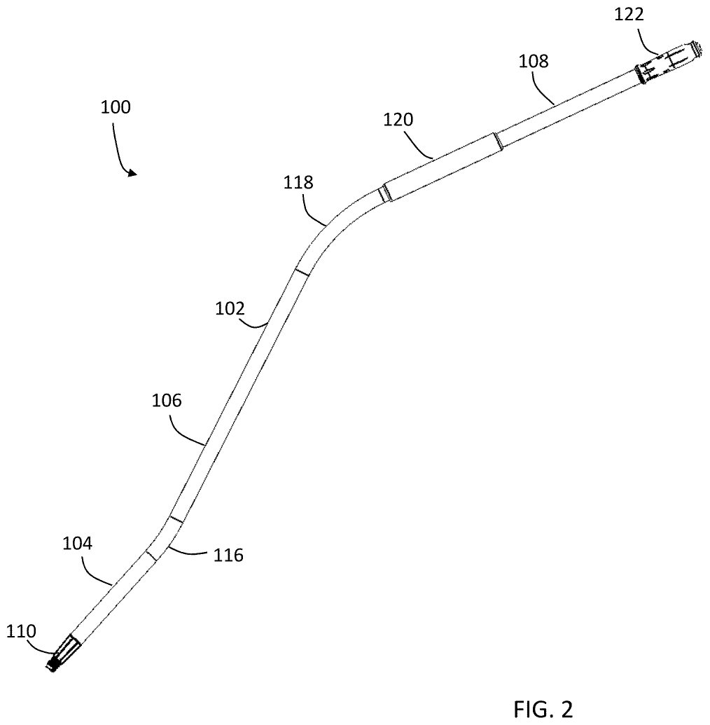

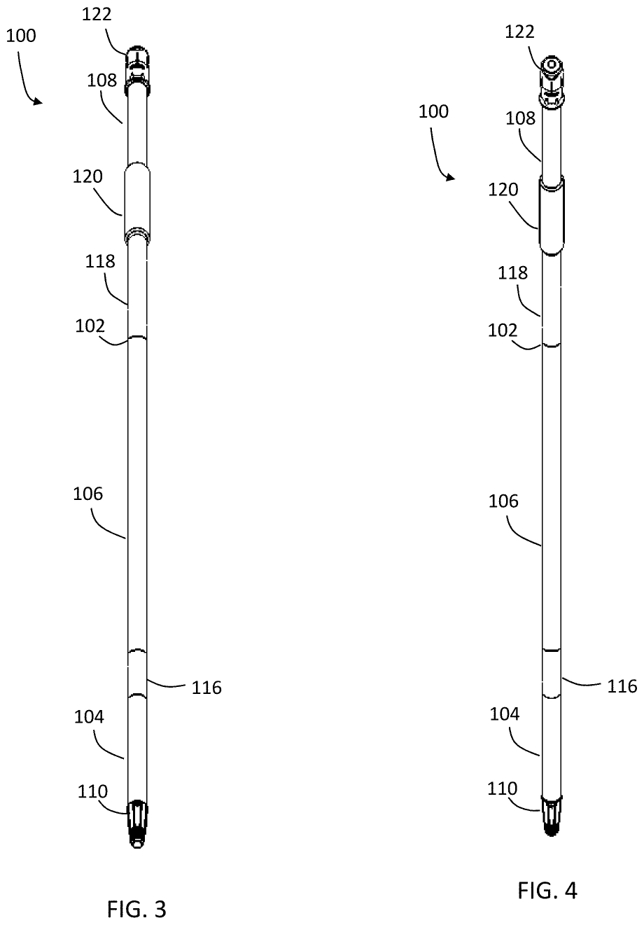

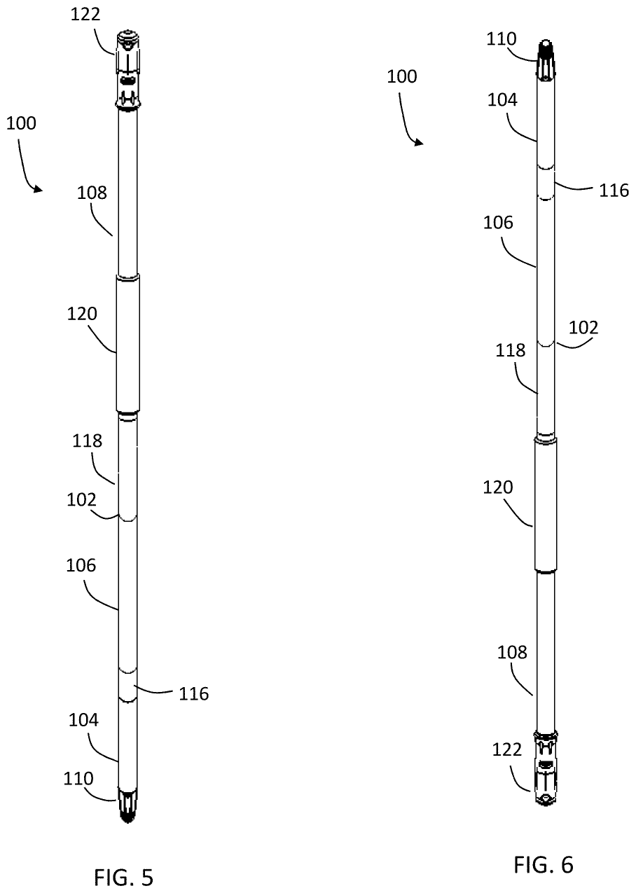

Referring now to FIGS. 1-8, an embodiment is shown of an ergonomic pole 100 for use with implements, such as cleaning implements. The pole 100 includes an elongated cylindrical handle or member 102. In the illustrated embodiment, the member 102 is a thin walled tubular member made from a metallic material, such as but not limited to: aluminum, steel, metallic alloys, fiberglass, carbon fiber and epoxy, or wood or a combination of the foregoing with or without grips, texture or surface treatments for example. It should be appreciated that other materials, such as a plastic/polymer material or a combination or plastic and metal for example. It should further be appreciated that while embodiments herein may describe the member 102 as being tubular or hollow, this is for example reasons and the claims should not be so limited. In other embodiments, the member 102 may be made from a solid material. It is also contemplated that the cross section can be other than cylindrical, such as oval, trilobal, etc. The pole surface can also be textured or have grips attached such as with adhesive.

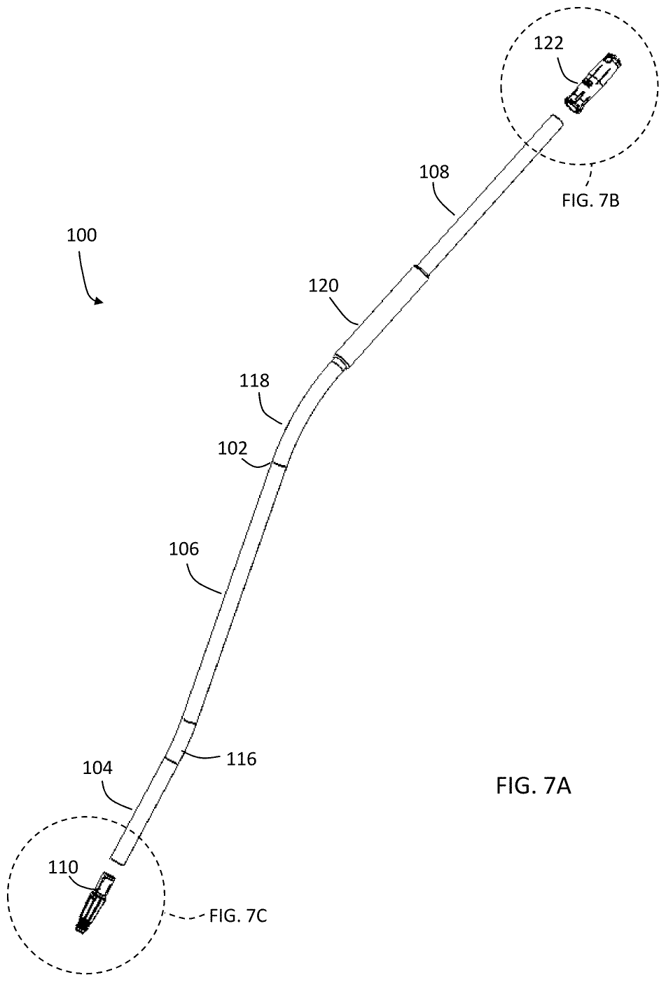

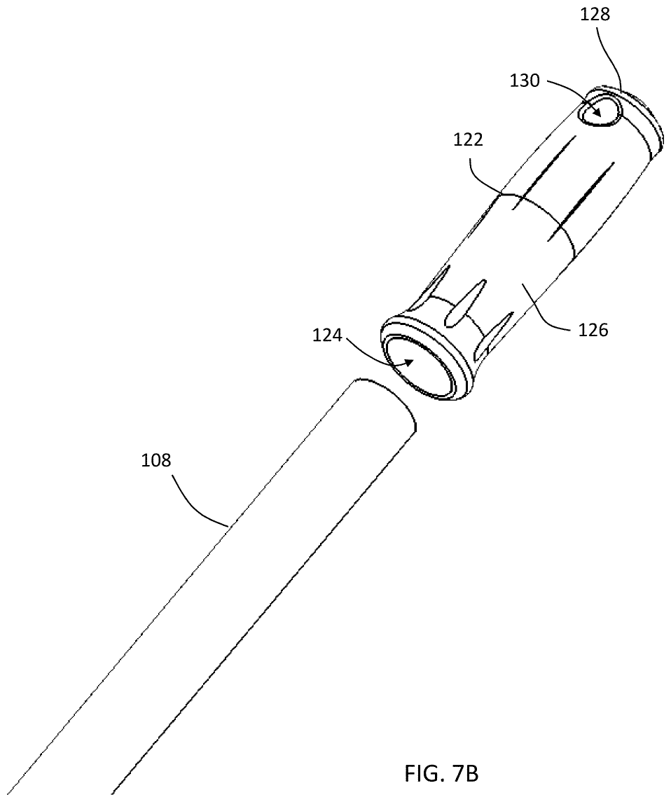

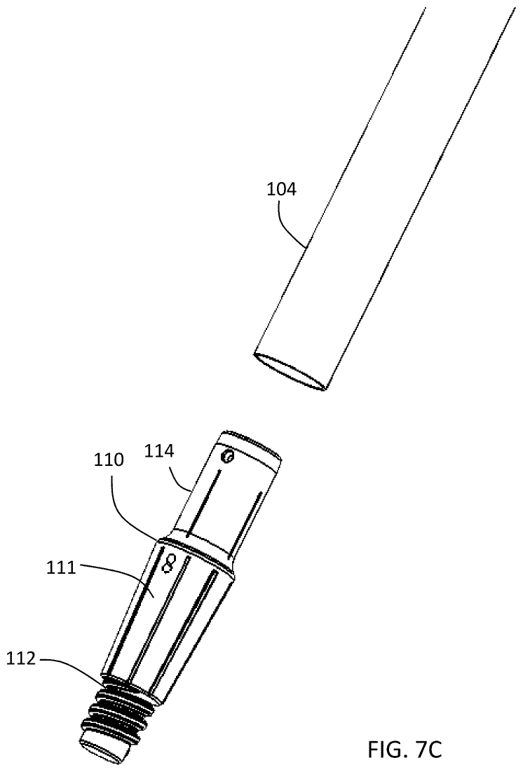

In the illustrated embodiment, the member 102 is comprised of a plurality of straight segments connected by curved segments. The straight segments are arranged to facilitate placing the implement at the desired orientation (angle relative to the surface it is placed) while allowing the user to push on the pole 100 and keep their back straight or substantial straight (e.g. not bent or hunched over) while making it easy (improving) to get the correct pushing (forward) and cleaning (downward) forces. The member 102 includes a first straight segment 104, a second straight segment 106, and a third straight segment 108. Coupled to the first straight segment 104 is a coupler 110. In an embodiment, the coupler 110 is configured to engage a corresponding member on the implement and secure the implement to the pole 100. In the illustrated embodiment, the coupler 110 has a threaded portion 112 and a cone portion 111 (FIG. 7C), however, any suitable coupling mechanism may be used. In an embodiment, the coupler 110 is removably coupled to the member 102 to allow a coupler with a different attachment means to be used. In the illustrated embodiment, the coupler 110 includes a cylindrical portion 114 sized to be received within the first straight segment 104. The coupler 110 may be secured to the first straight segment 104 by a fastener (not shown).

The second straight segment 106 is coupled to the first straight segment by a first curved segment 116. In the illustrated embodiment the radius and center of the curved segment 116 is sized and positioned such that the first straight segment and second straight segment extend tangentially from the curved segment 116.

The second straight segment 106 is coupled to the third straight segment 108 by a second curved segment 118. In the illustrated embodiment the radius and center of the second curved segment 118 is selected such that the first straight segment and second straight segment extend tangentially from the curved segment 116. Coupled to the third straight segment 108 is a grip member 120. The grip member 120 is made from a material that allows the user to comfortably hold the grip member for periods of use. The grip member 120 may be made from a material such as foam, thermoplastic elastomer (TPE), plastic, or the like. The grip could be smooth or have finger grips or contoured outer surface that is shaped to allow the user to comfortably hold and apply force to the pole. In an embodiment, the grip member 120 may be movable along the length of the third straight segment by the user. In an embodiment, the grip member 120 may be moved further down along the pole 100 onto the second curved member 118 or even the second straight segment 106 if desired by the user. Also coupled to the end of the third straight member 108 is a handle 122. The handle 122 includes an opening 124 on one end sized to receive the end of the third straight segment 108. The handle 122 includes a contoured outer surface 126 that is shaped to allow the user to comfortably hold and apply force to the pole 100. The end 128 of the handle 122 is curved to allow a user to comfortably place their palm on the end if desired during use. In an embodiment, the handle 122 may include a hole 130 that extends there through adjacent the end 128.

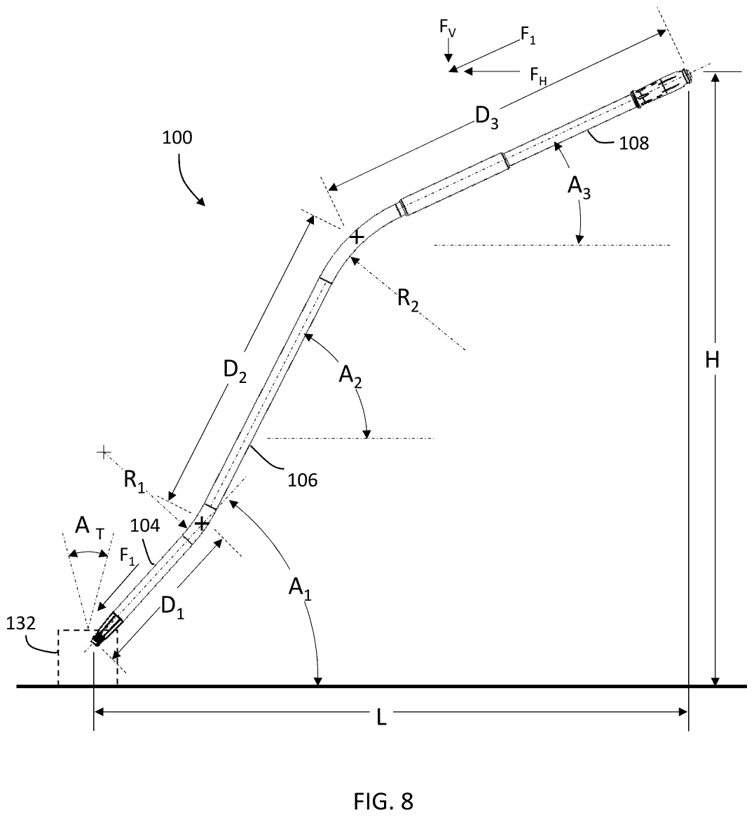

The proportions of the segments 104, 106, 108, 116, 118, 120, 122 will be discussed herein with respect to Table 1. The sizes and proportions are selected to provide a desired height H and length L while maintaining the first segment 104 at the desired angle A₁ to place the implement 132 (FIG. 8) at the desired orientation to the work surface. The angle A₁ is sometimes referred to as the functional angle as it is the angle of the first segment that places the implement at a desired orientation/angle.

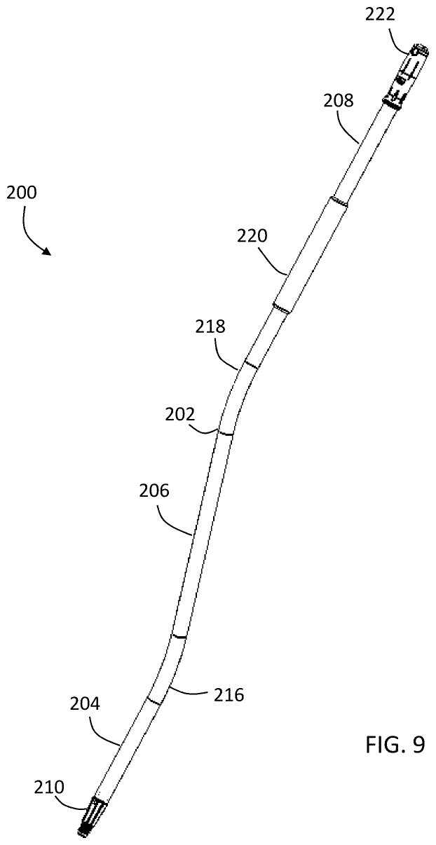

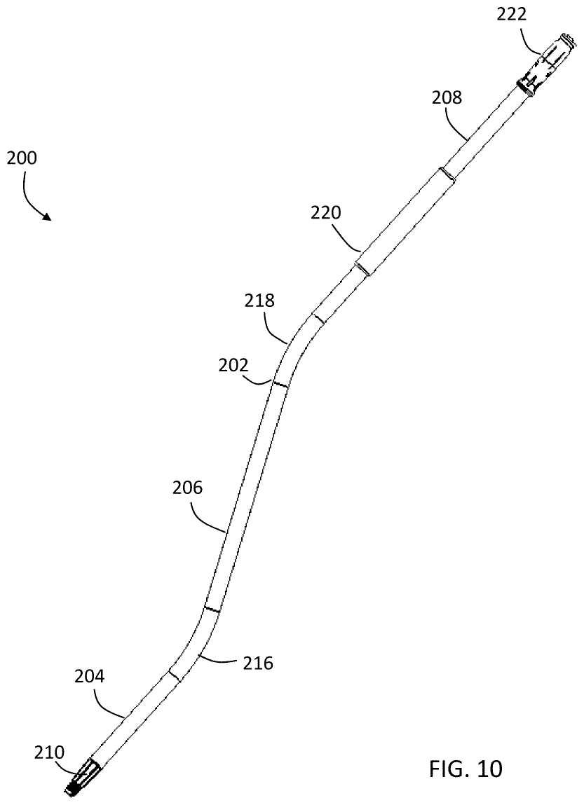

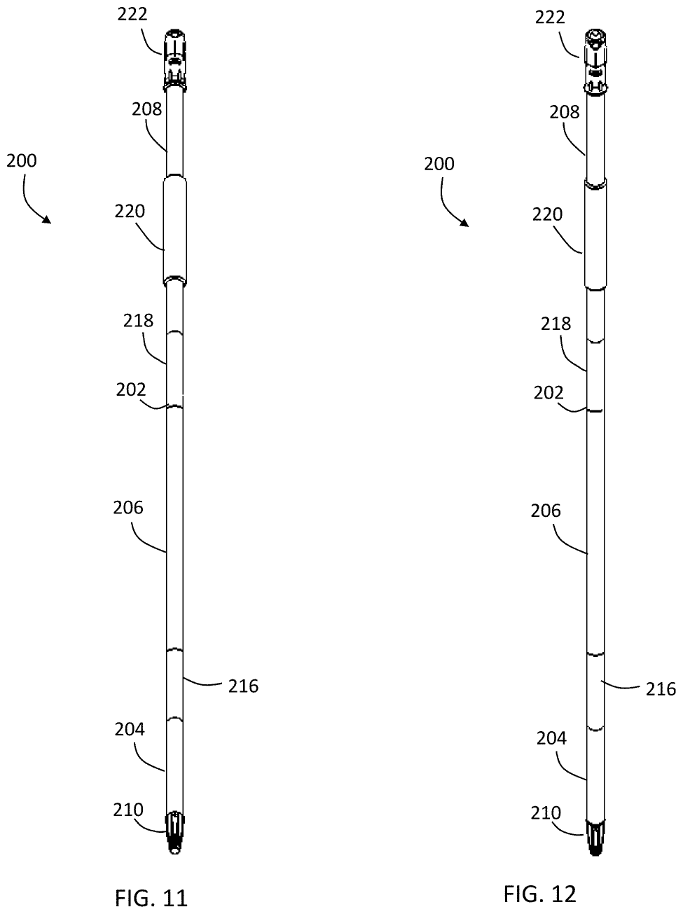

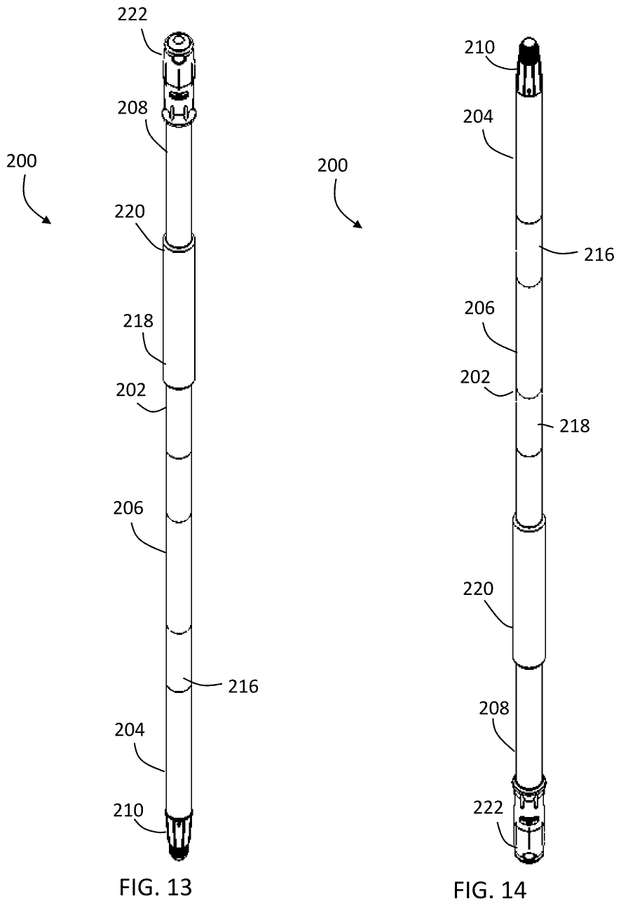

Referring now to FIGS. 9-14, an embodiment is shown of another pole 200 for use with implements, such as cleaning implements. Similar to the pole 100, the pole 200 includes an elongated cylindrical handle or member 202. In the illustrated embodiment, the member 202 is a thin walled tubular member made from a metallic material, such as but not limited to: aluminum, steel, metallic alloys, fiberglass, carbon fiber and epoxy, or wood or a combination of the foregoing with or without grips, texture or surface treatments for example. It should be appreciated that other materials, such as a plastic/polymer material or a combination or plastic and metal for example. It should further be appreciated that while embodiments herein may describe the member 202 as being tubular or hollow, this is for example reasons and the claims should not be so limited. In other embodiments, the member 102 may be made from a solid material. It is also contemplated that the cross section can be other than cylindrical, such as oval, trilobal, for example. The pole surface can also be textured or have grips attached such as with adhesive.

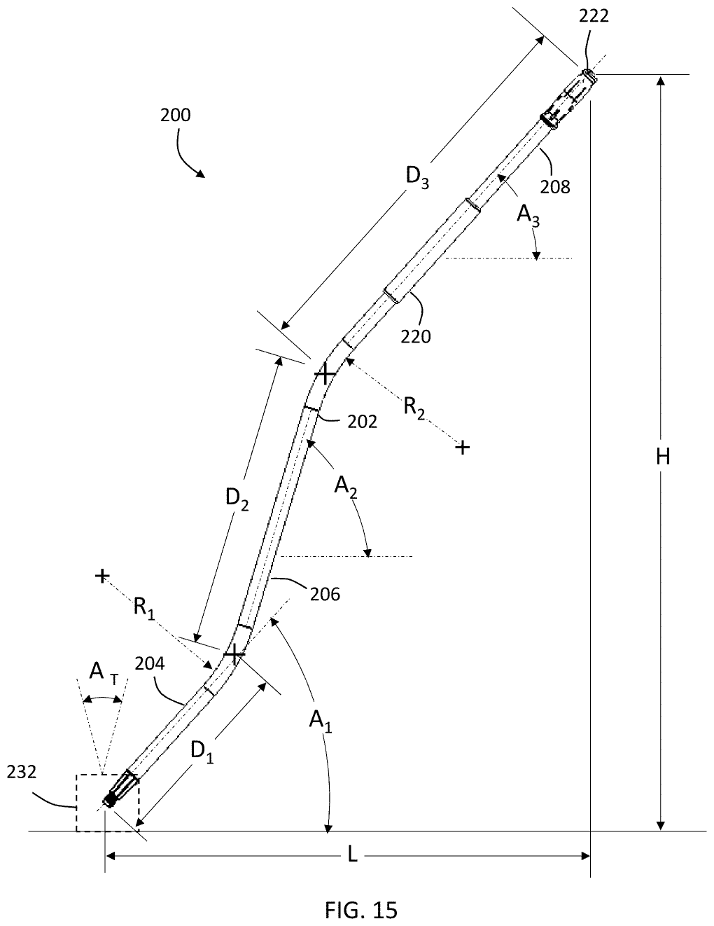

In this embodiment, the lengths and angles of the segments of member 202 provide for slightly higher height H and a shorter length L (FIG. 15) as will be discussed in more detail with respect to Table 1.

In the illustrated embodiment, the member 202 is a thin walled tubular member made from a metallic material, such as but not limited to: aluminum, steel, or metallic alloys, fiberglass, carbon fiber and epoxy, or wood or a combination of the foregoing with or without grips, texture or surface treatments for example. It should be appreciated that other materials, such as a plastic material or a combination or plastic and metal for example. It should further be appreciated that while embodiments herein may describe the member 202 as being tubular or hollow, this is for example reasons and the claims should not be so limited. In other embodiments, the member 202 may be made from a solid material.

In the illustrated embodiment, the member 202 is comprised of a plurality of straight segments connected by curved segments. The straight segments are arranged to facilitate placing the implement at the desired orientation (angle relative to the surface it is placed) while allowing the user to push on the pole 200 and keep their back straight or substantial straight (e.g. not bent or hunched over) while making it easy (improving) to get the correct pushing (forward) and cleaning (downward) forces. The member 202 includes a first straight segment 204, a second straight segment 206, and a third straight segment 208. Coupled to the first straight segment 204 is a coupler 210. In an embodiment, the coupler 210 is configured to engage a corresponding member on the implement and secure the implement to the pole 200. In the illustrated embodiment, the coupler 210 has a threaded portion and a cone portion, however, any suitable coupling mechanism may be used. In the illustrated embodiment, the coupler 210 is the same as the coupler 110. In an embodiment, the coupler 210 is removably coupled to the member 202 to allow a coupler with a different attachment means to be used. In the illustrated embodiment, the coupler 210 includes a cylindrical portion sized to be received within the first straight segment 204. The coupler 210 may be secured to the first straight segment 204 by a fastener (not shown). In an embodiment, the coupler 210 may be the same as that described in commonly owned U.S. Pat. No. 7,413,366, the contents of which are incorporated by reference herein.

The second straight segment 206 is coupled to the first straight segment by a first curved segment 216. In the illustrated embodiment the radius and center of the curved segment 216 is sized and positioned such that the first straight segment and second straight segment extend tangentially from the curved segment 216.

The second straight segment 206 is coupled to the third straight segment 208 by a second curved segment 218. In the illustrated embodiment the radius and center of the second curved segment 218 is selected such that the first straight segment and second straight segment extend tangentially from the curved segment 216. Coupled to the third straight segment 208 is a grip member 220. In an embodiment, the grip member 220 is the same as grip member 120. The grip member 220 is made from a material that allows the user to comfortably hold the grip member for periods of use. The grip member may be made from a material such as foam, TPE, plastic or the like. In an embodiment, the grip member 220 may be movable along the length of the third straight segment by the user. In an embodiment, the grip member 220 may be moved further down along the pole 200 onto the second curved member 218 or even the second straight segment 206 if desired by the user. Also coupled to the end of the third straight member 208 is a handle 222. In the illustrated embodiment, the handle 222 is the same as handle 122. The handle 122 includes an opening on one end sized to receive the end of the third straight segment 208. The handle 222 includes a contoured outer surface that is shaped to allow the user to comfortably hold and apply force to the pole 200. The end of the handle 222 is curved to allow a user to comfortably place their palm on the end if desired during use. In an embodiment, the handle 222 may include a hole that extends there through adjacent the end.

The proportions of the segments 204, 206, 208, 216, 218, 220, 222 will be discussed herein with respect to Table 1. The sizes and proportions are selected to provide a desired height H and length L while maintaining the first segment 204 at the desired angle A₁ to place the implement 232 (FIG. 15) at the desired orientation to the work surface.

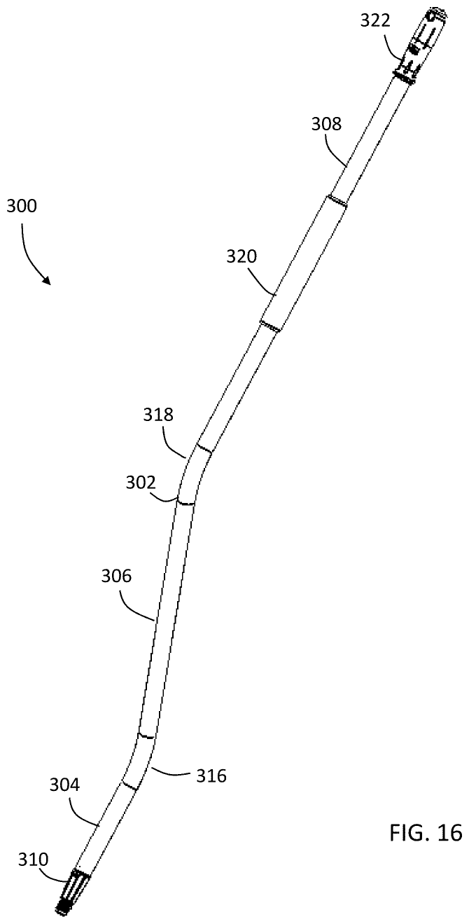

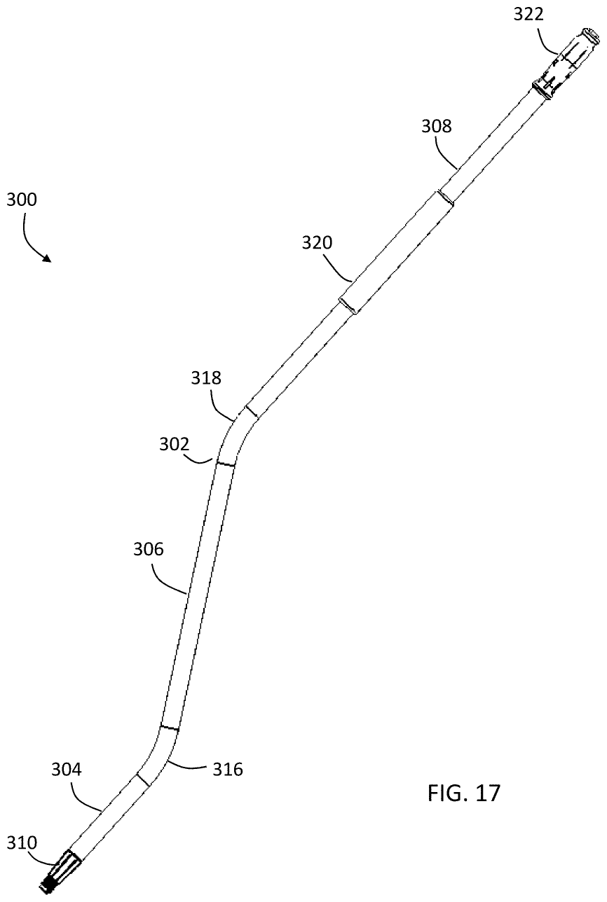

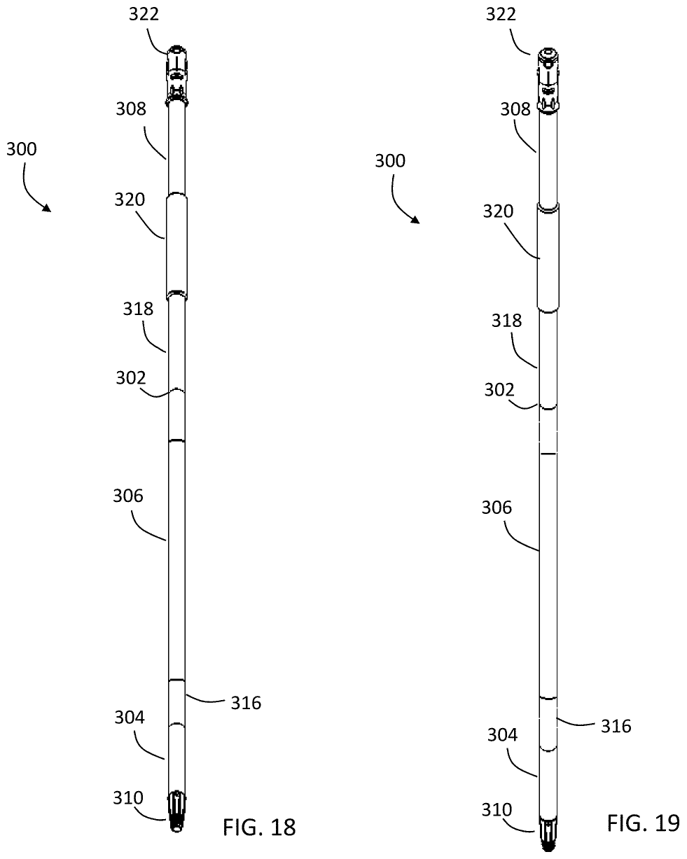

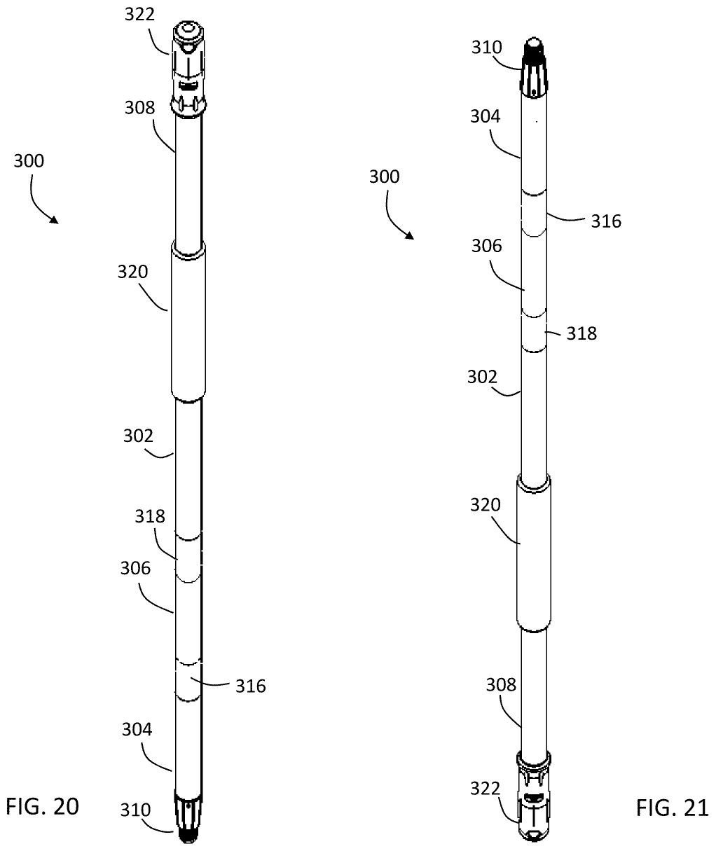

Referring now to FIGS. 16-21, an embodiment is shown of another pole 300 for use with implements, such as cleaning implements. Similar to the pole 100, the pole 300 includes an elongated cylindrical handle or member 302. In the illustrated embodiment, the member 302 is a thin walled tubular member made from a metallic material, such as but not limited to: aluminum, steel, metallic alloys, fiberglass, carbon fiber and epoxy, or wood or a combination of the foregoing with or without grips, texture or surface treatments for example. It should be appreciated that other materials, such as a plastic/polymer material or a combination or plastic and metal for example. It should further be appreciated that while embodiments herein may describe the member 302 as being tubular or hollow, this is for example reasons and the claims should not be so limited. In other embodiments, the member 102 may be made from a solid material. It is also contemplated that the cross section can be other than cylindrical, such as oval, trilobal, for example. The pole surface can also be textured or have grips attached such as with adhesive.

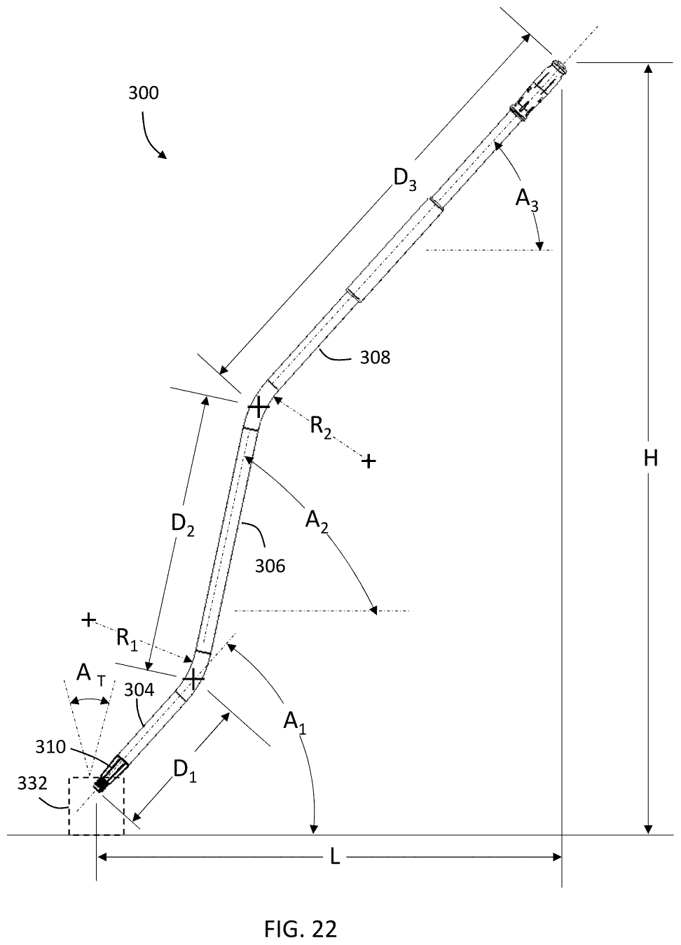

In this embodiment, the lengths and angles of the segments of member 302 provide for a higher height H and a shorter length L (FIG. 22) relative to the pole 100 as will be discussed in more detail with respect to Table 1.

In the illustrated embodiment, the member 302 is a thin walled tubular member made from a metallic material, such as but not limited to: aluminum, steel, or a metallic alloy for example. It should be appreciated that other materials, such as a plastic material or a combination or plastic and metal for example. It should further be appreciated that while embodiments herein may describe the member 302 as being tubular or hollow, this is for example reasons and the claims should not be so limited. In other embodiments, the member 302 may be made from a solid material.

In the illustrated embodiment, the member 302 is comprised of a plurality of straight segments connected by curved segments. The straight segments are arranged to facilitate placing the implement at the desired orientation (angle relative to the surface it is placed) while allowing the user to push on the pole 300 and keep their back straight or substantial straight (e.g. not bent or hunched over). The member 302 includes a first straight segment 304, a second straight segment 306, and a third straight segment 308. Coupled to the first straight segment 304 is a coupler 310. In an embodiment, the coupler 310 is configured to engage a corresponding member on the implement and secure the implement to the pole 300. In the illustrated embodiment, the coupler 310 has a threaded portion, however, any suitable coupling mechanism may be used. In the illustrated embodiment, the coupler 310 is the same as the coupler 110. In an embodiment, the coupler 310 is removably coupled to the member 302 to allow a coupler with a different attachment means to be used. In the illustrated embodiment, the coupler 310 includes a cylindrical portion sized to be received within the first straight segment 304. The coupler 310 may be secured to the first straight segment 304 by a fastener (not shown).

The second straight segment 306 is coupled to the first straight segment by a first curved segment 316. In the illustrated embodiment the radius and center of the curved segment 316 is sized and positioned such that the first straight segment and second straight segment extend tangentially from the curved segment 316.

The second straight segment 306 is coupled to the third straight segment 308 by a second curved segment 318. In the illustrated embodiment the radius and center of the second curved segment 318 is selected such that the first straight segment and second straight segment extend tangentially from the curved segment 316. Coupled to the third straight segment 308 is a grip member 320. In an embodiment, the grip member 320 is the same as grip member 120. The grip member 320 is made from a material that allows the user to comfortably hold the grip member for periods of use. In an embodiment, the grip member 320 may be movable along the length of the third straight segment by the user. In an embodiment, the grip member 320 may be moved further down along the pole 300 onto the second curved member 318 or even the second straight segment 306 if desired by the user. Also coupled to the end of the third straight member 308 is a handle 322. In the illustrated embodiment, the handle 322 is the same as handle 122. The handle 322 includes an opening on one end sized to receive the end of the third straight segment 308. The handle 322 includes a contoured outer surface that is shaped to allow the user to comfortably hold and apply force to the pole 300. The end of the handle 322 is curved to allow a user to comfortably place their palm on the end if desired during use. In an embodiment, the handle 322 may include a hole that extends there through adjacent the end.

The proportions of the segments 304, 306, 308, 316, 318, 320, 322 will be discussed herein with respect to Table 1. The sizes and proportions are selected to provide a desired height H and length L while maintaining the first segment 204 at the desired angle A₁ to place the implement 332 (FIG. 22) at the desired orientation to the work surface.

As discussed herein, it is desired to provide an ergonomic handle that allows the operator to use the implement, such as to clean a work surface, without having the user bend or hunch-over with their back. In order words, keep the users back straight, or substantially straight during operation. This is accomplished while maintaining the first segment 104, 204, 304 at the desired angle for efficient operation of the implement. Referring now to FIG. 8, FIG. 15, and FIG. 22, dimensions for examples of ergonomic poles 100, 200, 300, 400 is shown in accordance with one or more embodiments, where the angle A_{T} is the angle from vertical at which the implement may be efficiently operated:

TABLE 1

| Type | A1 (Deg) | A3 (Deg) | AT (Deg) | H (mm) |
|---|---|---|---|---|
| Pole 100 | 30-50 | 15-35 | +/−15 | 760-1270 |
| Pole 200 | 30-50 | 35-50 | +/−15 | 890-1400 |
| Pole 300 | 30-50 | 35-50 | +/−15 | 890-1400 |
| Pole 400 | 30-50 | 15-50 | +/−15 | 760-1270 |

The lengths of the straight segments D₁, D₂, D₃ are measured from the intersection of the centerlines (datum point) of the respective straight segments. The height H of the end of the handle is measured to the intersection of the centerline of the third straight segment and the end surface of the handle. The length of the pole is measured from the intersection of the centerline of the first straight segment and the bottom of the coupler to the intersection of the centerline of the third straight segment and the end surface of the handle. It has been found that that when the end of the pole 100, 200, 300 is placed at the height H, length L and angle A₁, the implement operates at the desired efficiency. It should be appreciated that the pole selected by the user may depend on the height of the user. A user who is taller may prefer pole 100 or pole 200, which have a higher operating height, while a user who is shorter may prefer pole 300 that has a lower operating height.

In one or more other embodiments, dimensions for the ergonomic poles 100, 200, 300, 400 may include:

TABLE 2

| Type | A1 (Deg) | A3 (Deg) | AT (Deg) | H (mm) |
|---|---|---|---|---|
| Pole 100 | 10-80 | 0-60 | +/−30 | 505-1270 |
| Pole 200 | 10-80 | 0-60 | +/−30 | 635-1400 |
| Pole 300 | 10-80 | 0-60 | +/−30 | 635-1400 |
| Pole 400 | 10-80 | 0-60 | +/−30 | 505-1270 |

In still further embodiments, dimensions for the ergonomic poles 100, 200, 300 may include:

TABLE 3

| Type | D1 | D2 | D3 | R1 | R2 | A1 | A2 | A3 | AT | H | L |
|---|---|---|---|---|---|---|---|---|---|---|---|
| Pole 100 | 150-240 | 620-640 | 680-710 | 165-300 | 165-300 | 40-50 | 55-65 | 17-27 | +/−15 | 1050-1100 | 1060-1100 |
| Pole 200 | 200-270 | 525-550 | 670-700 | 165-300 | 165-300 | 40-50 | 70-75 | 40-50 | +/−15 | 1200-1275 | 790-820 |
| Pole 300 | 150-200 | 480-500 | 770-790 | 165-300 | 165-300 | 40-50 | 70-85 | 40-50 | +/−15 | 1200-1275 | 750-770 |

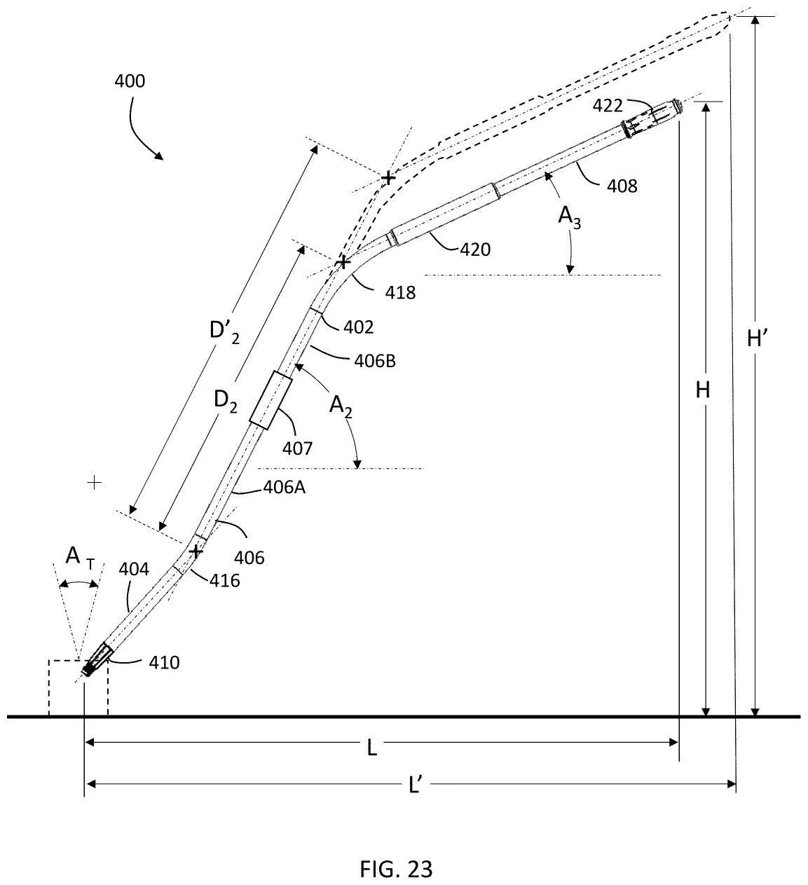

Referring now to FIG. 23, an embodiment is shown of a pole 400 that includes an adjustable straight segment that allows the pole 400 to be changed to accommodate users of different heights. The pole 400 includes an elongated cylindrical handle or member 402. The member 402 is comprised of a first straight segment 404, an adjustable second straight segment 406 and a third straight segment 408. Similar to the pole 100, the first straight segment is connected to the adjustable second straight segment 406 by a first curved segment 416. The adjustable second straight segment is connected to the third straight segment by a second curved segment 418. A coupler 410 is coupled to the end of the first straight segment 404. A grip member 420 and a handle 422 are coupled to the third straight segment 408. In an embodiment, the coupler 410, the grip member 420 and the handle 422 are the same as the coupler 110, the grip member 120 and the handle 122 respectively.

In this embodiment, the second segment 406 is adjustable between a first position (shown in solid line in FIG. 23) having a length D₂ to a second position (shown in dashed line in FIG. 23) with a length D₂′. It should be appreciated that while when the length of the second segment 406 is changed, the height of the end of the handle will increase from a height H to a second height H′. Similarly, the length of the pole 400 will change from the initial length L to a second length L′.

In an embodiment, the second segment 406 includes two portions 406A, 406B that are coupled by one or more collars 407 or clamps. The collar 407 may be tightened or loosened to allow one of the two portions 406A, 406B to slide into the other of the two portions 406A, 406B to change the length of the second segment 406 or a clamp can be used. It should be appreciated that the two portions 406A, 406B may have different diameters. When at the desired length, the collar 407 is tightened to fix the second segment 406 at that length. In an embodiment, the length of the second straight segment is adjustable based on the number of collars that are used as shown in Table 4:

TABLE 4

| | Adjustment | | |
|---|---|---|---|
| Embodiment | Range | First Length | Second Length |
| One collar | 350 mm | 450 mm | 800 mm |
| Two collars | 550 mm | 450 mm | 1000 mm |

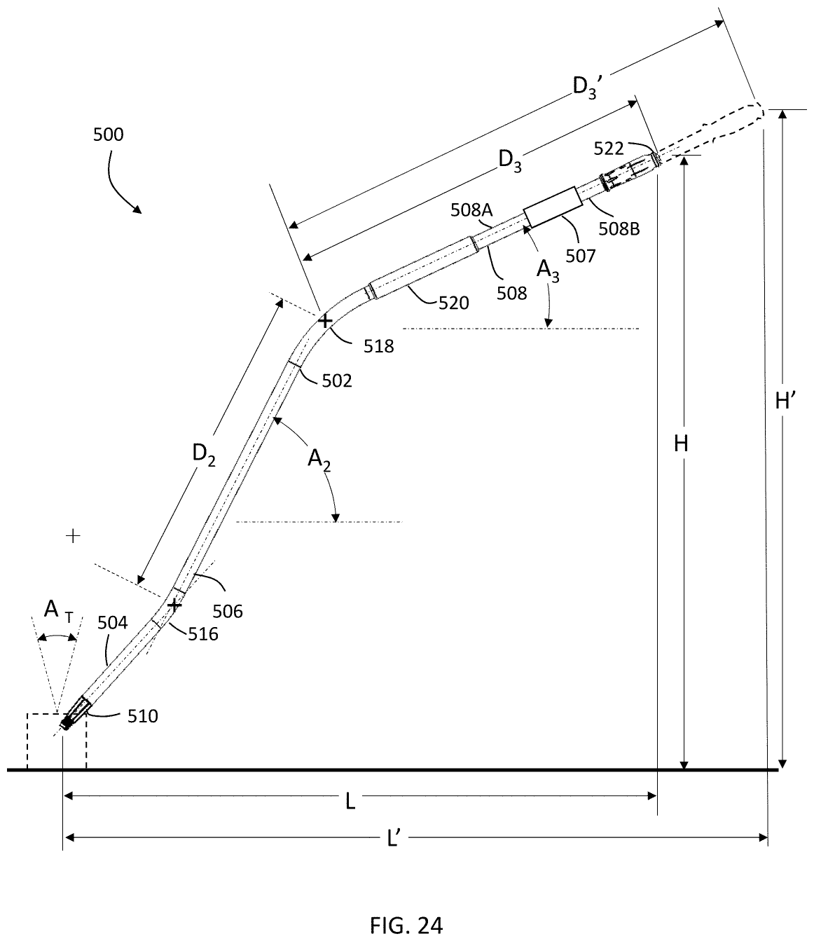

Referring now to FIG. 24, an embodiment is shown of a pole 500 that includes an adjustable straight segment that allows the pole 500 to be changed to accommodate users of different heights and/or a different length. The pole 500 includes an elongated cylindrical handle or member 502. The member 502 is comprised of a first straight segment 504, a second straight segment 506 and an adjustable third straight segment 508. Similar to the pole 100, the first straight segment is connected to the adjustable second straight segment 506 by a first curved segment 516. The second straight segment is connected to the adjustable third straight segment by a second curved segment 518. A coupler 510 is coupled to the end of the first straight segment 504. A grip member 520 and a handle 522 are coupled to the adjustable third straight segment 508. In an embodiment, the coupler 510, the grip member 520 and the handle 522 are the same as the coupler 110, the grip member 120 and the handle 122 respectively.

In this embodiment, the third segment 508 is adjustable between a first position (shown in solid line in FIG. 24) having a length D₃ to a second position (shown in dashed line in FIG. 24) with a length D₃′. It should be appreciated that while when the length of the third segment 508 is changed, the height of the end of the handle will increase from a height H to a second height H′. Similarly, the length of the pole 500 will change from the initial length L to a second length L′.

In an embodiment, the third segment 508 includes two portions 508A, 508B that are coupled by a collar 507 or a clamp. The collar 507 may be tightened or loosened to allow one of the two portions 508A, 508B to slide into the other of the two portions 508A, 508B to change the length of the third segment 508. It should be appreciated that the two portions 508A, 508B may have different diameters. When at the desired length, the collar 507 is tightened to fix the second segment 508 at that length. In an embodiment, the length of the third straight segment is adjustable depending on the number of collars used as shown in Table 5:

TABLE 5

| | Adjustment | | |
|---|---|---|---|
| Embodiment | Range | First Length | Second Length |
| One collar | 500 mm | 600 mm | 1100 mm |
| Two collars | 775 mm | 425 mm | 1200 mm |

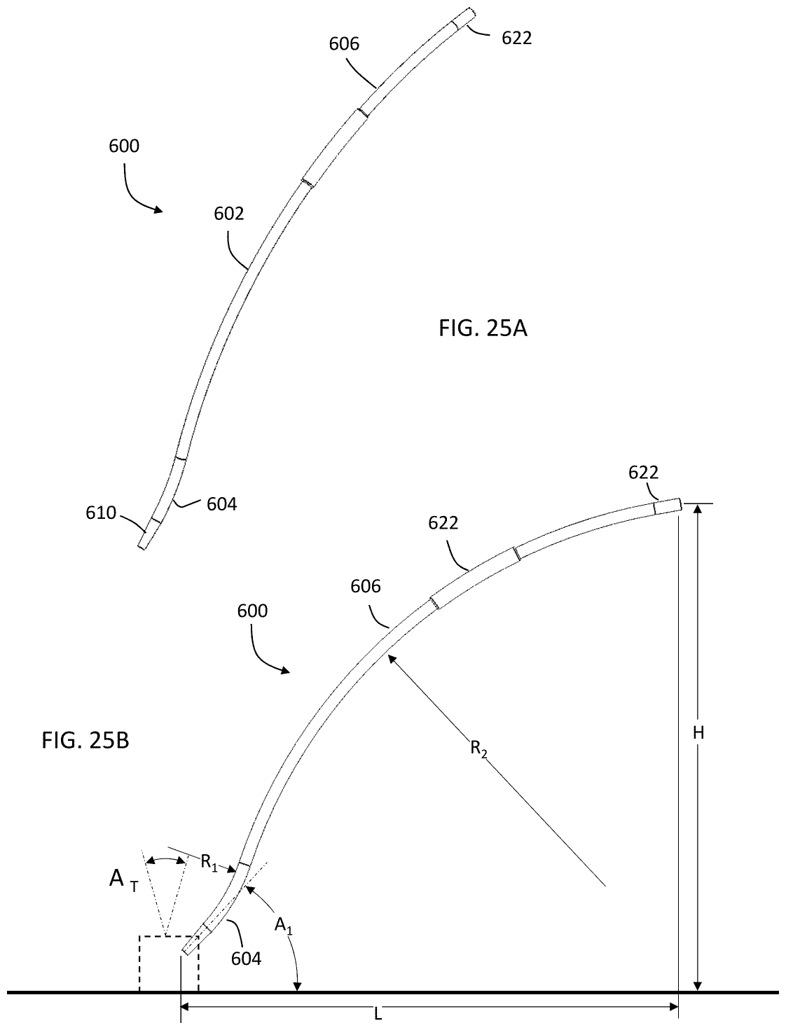

Referring now to FIG. 25A and FIG. 25B, another embodiment is shown of a pole 600. The pole 600 includes an elongated cylindrical handle or member 602 having a coupler 610 at a first end and a handle 622 at an opposite end. In an embodiment, the coupler 610 is the same as coupler 110 and the handle 622 is the same as handle 122. In this embodiment, the member 602 includes a first curved segment 604 and a second segment 606. The segments 604, 606 are sized to place the handle 622 at a height H of about 25-50 inches about the surface while maintaining the implement at the desired orientation/angle A_{T}. In the illustrated embodiment, the angle A1 may be between 10-80 degrees, between 30-50 degrees or between 40-50 degrees. In this embodiment, the first segment has a curved radius R₁ and the second segment has a curved radius R₂. In the illustrated embodiment, the radius R1 is about 200-600 mm and the radius R₂ is about 1000-1400 mm. A grip member 622 is disposed on and coupled to the second segment 606.

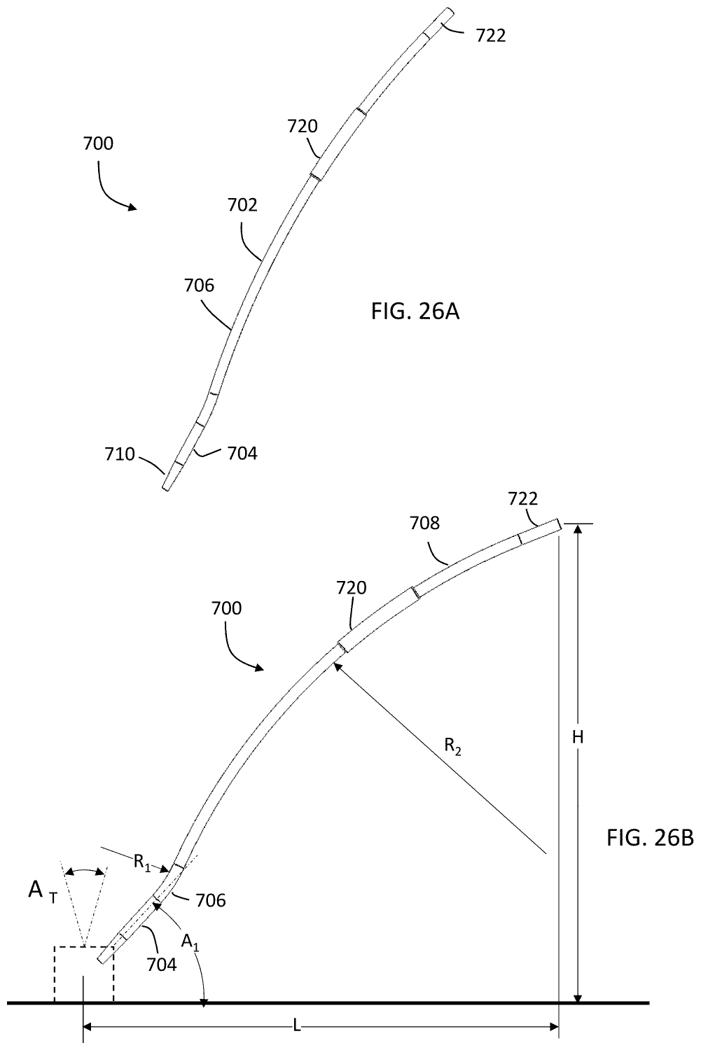

Referring now to FIG. 26A and FIG. 26B, another embodiment is shown of a pole 700. The pole 700 includes an elongated cylindrical handle or member 702 having a coupler 710 at a first end and a handle 722 at an opposite end. In an embodiment, the coupler 710 is the same as coupler 110 and the handle 722 is the same as handle 122. In this embodiment, the member 702 includes a first straight segment 704, a second curved segment 706, and a third curved segment 708. The segments 704, 706, 706 are sized to place the handle 722 at a height H of about 25-50 inches about the surface while maintaining the implement at the desired orientation/angle A_{T}. In the illustrated embodiment, the angle A₁ may be between 10-80 degrees, between 30-50 degrees, or between 40-50 degrees. In this embodiment, the second segment has a curved radius R₁ and the third segment has a curved radius R₂. In the illustrated embodiment, the radius R₁ is about 200-400 mm and the radius R₂ is about 1300-1700. A grip member 720 is disposed on and coupled to the second segment 708.

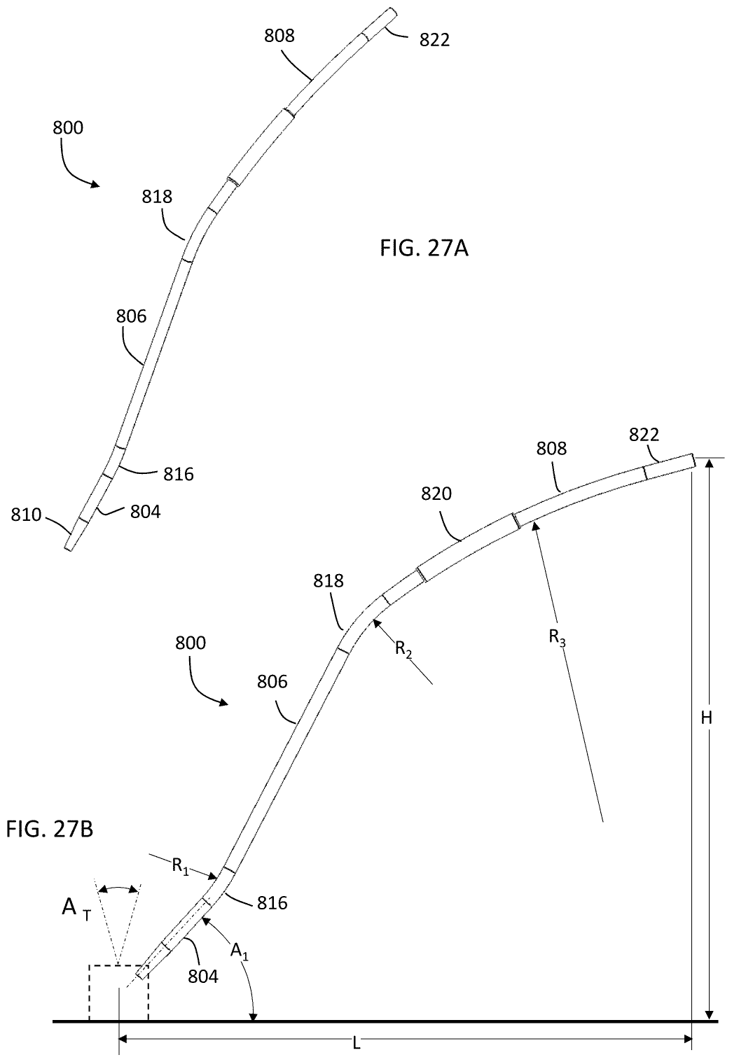

Referring now to FIG. 27A and FIG. 27B, another embodiment is shown of a pole 800. The pole 800 includes an elongated cylindrical handle or member 820 having a coupler 810 at a first end and a handle 822 at an opposite end. In an embodiment, the coupler 810 is the same as coupler 110 and the handle 822 is the same as handle 122. In this embodiment, the member 802 includes a first straight segment 804, a second straight segment 806, and a third curved segment 808. The segments 804, 806, 808 are sized to place the handle 822 at a height H of about 25-50 inches about the surface while maintaining the implement at the desired orientation/angle A_{T}. In the illustrated embodiment, the angle A₁ may be between 10-80 degrees, between 30-50 degrees, or between 40-50 degrees. The first segment 804 is connected to the second segment 806 by a curved segment 816 having a radius R₁. In an embodiment, the radius R₁ is about 1200-1400 mm. The second segment is connected to the third segment 808 with a curved segment 818 having a radius R₂. In an embodiment, the radius R₂ is about 200-400 mm. In this embodiment, the third segment has a curved radius R₃. In the illustrated embodiment, the radius R₃ is about 1300-1700. A grip member 720 is disposed on and coupled to the second segment 708.

It should be noted that the terms “first,” “second,” “third,” “upper,” “top,” “bottom,” “lower,” “front,” and “rear” and the like may be used herein to modify various elements. These modifiers do not imply a spatial, sequential, or hierarchical order to modify the elements unless specifically stated. The term “about” is intended to include the degree of error associated with measurement of the particular quantity based upon the equipment available at the time of filing the application.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. An ergonomic pole for a floor cleaning implement comprising:
a pole having a first end and a second end, the pole further having a first segment adjacent the first end, a third segment adjacent the second end and a second segment disposed between the first segment and the third segment; and
a cleaning implement coupled to the first end;
wherein the third segment is disposed on an angle of about 25 degrees to 40 degrees relative to a surface being cleaned when the floor cleaning implement is in an operating position, and
wherein the second end is positioned about 630-1400 mm from the surface when the floor cleaning implement is in the operating position.

2. The ergonomic pole of claim 1, wherein the first segment is disposed on an angle of about 30 to 60 degrees when the floor cleaning implement is in the operating position.

3. The ergonomic pole of claim 1, wherein the first segment is disposed on an angle of about 35-50 degrees when the floor cleaning implement is in the operating position.

4. The ergonomic pole of claim 1, wherein the second segment is configured to change length.

5. The ergonomic pole of claim 1, wherein the pole includes a first curved portion between the first segment and the second segment, and a second curved portion between the second segment and the third segment.

6. The ergonomic pole of claim 1, wherein the first segment has a first axis, the second segment has a second axis, and the third segment includes a third axis, a first intersection of the first axis and the second axis defining a first datum point, a second intersection of the second axis and the third axis defining a second datum point.

7. The ergonomic pole of claim 6, wherein the third segment has a length of about 670-790 mm from the second datum point to the second end.

8. The ergonomic pole of claim 7, wherein the first segment has a length of about 150-270 mm inches from the first end to the first datum point.

9. The ergonomic pole of claim 8, wherein the second segment is adjustable from a first length to a second length, a height H changes from 635 mm to 1270 mm when the second segment changes from the first length to the second length and the floor cleaning implement is at a functional angle.

10. The ergonomic pole of claim 9, wherein the functional angle is between 30 to 60 degrees.

11. The ergonomic pole of claim 10, wherein the functional angle is between 35 to 50 degrees.

12. An ergonomic pole for a floor cleaning implement comprising:
a pole having a first end and a second end, the pole further having a first segment adjacent the first end, a third segment adjacent the second end and a second segment disposed between the first segment and the third segment, the first segment having a first axis, the second segment having a second axis and the third segment having a third axis, a first intersection of the first axis and the second axis defining a first datum point, a second intersection of the second axis and the third axis defining a second datum point;
a cleaning implement coupled to the first end, and
wherein the pole has dimensions A₃, A₁, and H as defined by Table 2.

13. The ergonomic pole of claim 12, wherein the pole has the dimensions A₁, A₃ and H as defined by Table 1.

14. The ergonomic pole of claim 13, wherein the pole has dimensions D₁and D₃ as defined by Table 3.

15. The ergonomic pole of claim 14, wherein the pole has dimension D₂ as defined by Table 3.

16. The ergonomic pole of claim 15, wherein:
the pole further comprises a first curved segment connected between the first segment and the second segment, and a second curved segment connected between the second segment and the third segment;
the first curved segment has a radius defined by dimension R₁ as defined by Table 3; and
the second curved segment has a radius defined by dimension R₂ as defined by Table 3.

17. The ergonomic pole of claim 12, wherein the second segment is configured to have an adjustable length.

18. The ergonomic pole of claim 12, further comprising a coupler member coupled to an end of the first segment.

19. The ergonomic pole of claim 18, wherein the coupler member has a threaded portion configured to couple the coupler member to the cleaning implement.

20. The ergonomic pole of claim 18, further comprising a handle coupled to an end of the third segment.

21. The ergonomic pole of claim 20, further comprising a grip member coupled to the third segment.

22. An ergonomic pole for a floor cleaning implement comprising:
a pole having a first end and a second end, the pole further having a first segment adjacent the first end, a third segment adjacent the second end and a second segment disposed between the first segment and the third segment; and
a cleaning implement coupled to the first end,
wherein the first segment is disposed on a functional angle of about 30 degrees to 60 degrees relative to a surface being cleaned when the floor cleaning implement is in an operating position, and
wherein the second segment is adjustable from a first length to a second length, a height of an end of the third segment above the surface when in the operating position changes from 635 mm to 1270 mm when the second segment changes from the first length to the second length.
